(19) United States
(12) Patent Application Publication
(10) Pub. No.: US 2020/0299480 A1
(43) Pub. Date: Sep. 24, 2020

(54) MEMBER WITH AEROGEL LAYER

(71) Applicant: HITACHI CHEMICAL COMPANY, LTD., Tokyo (JP)

(72) Inventors: Yuta AKASU, Chiyoda-ku, Tokyo (JP); Tatsuya MAKINO, Chiyoda-ku, Tokyo (JP); Hiroyuki IZUMI, Chiyoda-ku, Tokyo (JP); Masato MIYATAKE, Chiyoda-ku, Tokyo (JP)

(21) Appl. No.: 16/089,439

(22) PCT Filed: Dec. 6, 2016
(86) PCT No.: PCT/JP2016/086180

§ 371 Date: Sep. 28, 2018

(30) Foreign Application Priority Data
Mar. 29, 2016 (JP) 2016-065485

(51) Int. Cl. C08J 9/28; C09D 1/00; F16L 59/02

(52) U.S. Cl. CPC C08J 9/28; C09D 1/00; C08J 2201/05; C08J 2205/026; F16L 59/029

(57) ABSTRACT

The present invention relates to a member with an aerogel layer comprising a main body part, the aerogel layer, and a barrier layer containing a siloxane compound in this order.

### TECHNICAL FIELD

The present invention relates to a member with an aerogel layer.

### BACKGROUND ART

In recent years, as the demands on the comfort of living space and energy saving have increased, there is a tendency that the shapes of thermal insulation objects are complicated, and the installation space of thermal insulating materials is narrowed. Thus, further improvement in thermal insulation properties and reduction in thickness are required for thermal insulating materials used in these.

Conventional thermally insulated structures include, for example, expandable thermal insulating materials such as urethane foam and phenol foam as constituent materials. However, these materials have a narrow service temperature range and employ the thermal insulation properties of air. Therefore, materials that have a wide service temperature range and have better thermal insulation properties than those of air must be developed for further improvement in thermal insulation properties.

As thermal insulating materials having better thermal insulation properties than those of air, there are thermal insulating materials in which voids forming foam are filled with a low thermally conductive gas by use of chlorofluorocarbon or a chlorofluorocarbon alternative blowing agent, etc. However, such thermal insulating materials have the possibility of leak of the low thermally conductive gas due to time degradation, and reduction in thermal insulation properties is a concern (e.g., Patent Literature 1 described below).

One in which calcium silicate or a nonwoven fabric is placed in an airtight bag and packaged in a vacuum state is also known as a vacuum insulating material and has better thermal insulation properties than those of air (e.g., Patent Literature 2 described below). However, in the vacuum insulating material, thermal insulation properties decrease drastically due to a problem such as time degradation or scratches on packaging bags, and furthermore, there is the problem that the thermal insulating material has no flexibility and cannot be processed into curved surfaces because of being vacuum-packaged.

Aerogel is currently known as a material having the lowest thermal conductivity at normal pressure (e.g., Patent Literature 3 described below). The aerogel has a microporous structure, whereby the transfer of a gas including air is suppressed so that thermal conduction decreases.

### CITATION LIST

### Patent Literature

Patent Literature 1: Japanese Patent No. 4084516

Patent Literature 2: Japanese Patent No. 4898157

Patent Literature 3: U.S. Pat. No. 4,402,927

### SUMMARY OF INVENTION

### Technical Problem

For thermal insulation methods using aerogel, novel modes of use are required from the viewpoint of achieving an excellent thermal insulation effect on a wide variety of thermal insulation objects.

Meanwhile, since the aerogel has a microporous structure, a problem is that a liquid or mist is absorbed into the pores in the aerogel in an environment where a liquid or mist of an oil and the like is present.

The present invention has been made in light of the situation described above, and an object thereof is to provide a member with an aerogel layer having excellent oil resistance.

### Solution to Problem

The present inventor has conducted diligent studies in order to attain the object described above and consequently found a member with an aerogel layer comprising a main body part, the aerogel layer, and a barrier layer containing a siloxane compound in this order, reaching the completion of the present invention.

The present invention provides a member with an aerogel layer comprising a main body part, the aerogel layer, and a barrier layer containing a siloxane compound in this order. The member with an aerogel layer of the present invention has excellent oil resistance. Also, the member with an aerogel layer of the present invention has excellent thermal insulation properties, flame retardance and heat resistance while the falling of aerogel can be suppressed.

In the present invention, the aerogel layer may comprise aerogel being a dried product of wet gel, the wet gel being a condensate of sol containing at least one selected from the group consisting of a silicon compound having a hydrolyzable functional group or a condensable functional group, and a hydrolysis product of the silicon compound having a hydrolyzable functional group. Provided that the aerogel layer is such matter, thermal insulation properties, flame retardance and flexibility can be achieved at high levels. Further, such an aerogel layer is considered to be also excellent in workability. Aerogel generally tends to be fragile. For example, monolithic aerogel may be broken by mere lifting by the hand. By contrast, aerogel sheets using aerogel and a reinforcing material have heretofore been devised. However, when the aerogel itself is fragile, it is possible that problems associated with workability arise in such a way that the sheets rupture due to shock or folding work, and aerogel powders fall out of the sheets. On the other hand, provided that the aerogel layer is the one mentioned above, it is considered that the fragility of aerogel is reduced, and workability improves.

The aerogel layer may comprise aerogel being a dried product of wet gel, the wet gel being a condensate of sol containing silica particles. By this, much better thermal insulation properties and flexibility can be achieved.

An average primary particle diameter of the silica particles may be 1 to 500 nm. By this, thermal insulation properties and flexibility improve more easily.

### Advantageous Effects of Invention

According to the present invention, a member with an aerogel layer having excellent oil resistance can be provided. Furthermore, the member with an aerogel layer of the present invention is also excellent in thermal insulation properties, flame retardance and heat resistance.

### BRIEF DESCRIPTION OF DRAWINGS

FIG. 1 is a sectional view schematically showing a member with an aerogel layer according to one embodiment of the present invention.

FIG. 2 is a diagram showing a method for calculating the two-axis average primary particle diameter of particles.

### DESCRIPTION OF EMBODIMENTS

Hereinafter, embodiments of the present invention will be described in detail with reference to the drawings, if necessary. However, the present invention is not limited by the following embodiments. In the present specification, a numerical range represented by using “to” means a range including the numerical values described before and after “to” as the minimum value and the maximum value, respectively. In numerical ranges described in stages in the present specification, the upper limit value or the lower limit value of a numerical range of a certain stage may be replaced with the upper limit value or the lower limit value of a numerical range of a different stage. In a numerical range described in the present specification, the upper limit value or the lower limit value of the numerical range may be replaced with a value shown in Examples. “A or B” needs only to include either A or B and may include both. Materials listed in the present embodiment can be used each alone or in combination of two or more thereof, unless otherwise specified. In the present specification, in the case where a plurality of substances corresponding to each component are present in a composition, the content of each component in the composition means the total amount of the plurality of substances present in the composition, unless otherwise specified.

<Member with Aerogel Layer>

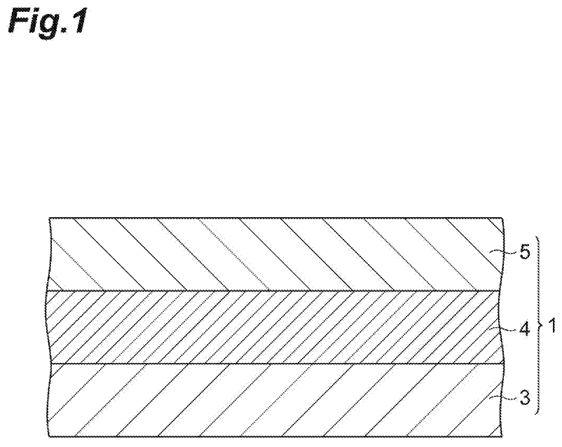

FIG. 1 is a sectional view schematically showing the member with an aerogel layer of the present embodiment. A member 1 with an aerogel layer (aerogel composite or aerogel composite structure) of the present embodiment comprises, as shown in FIG. 1, a main body part 3, an aerogel layer 4, and a barrier layer 5 containing a siloxane compound in this order. The main body part 3 is, for example, a support part supporting the aerogel layer 4. The main body part 3 is, for example, a thermal insulation object. The barrier layer 5 is, for example, a layer having barrier properties against oils and the like. The barrier layer 5 is a non-aerogel layer. The member 1 with an aerogel layer of the present embodiment is excellent in oil resistance, thermal insulation properties, flame retardance and heat resistance. Also, according to the member 1 with an aerogel layer of the present embodiment, since the absorption of liquids and mists of oils and the like can be suppressed, reduction in thermal insulation properties attributed thereto, etc. can be suppressed, and a stable thermal insulation effect can be obtained even in the presence of liquids and mist. Moreover, according to the member 1 with an aerogel layer of the present embodiment, the falling of aerogel can be suppressed.

For example, a method of mixing a resin or the like with an aerogel powder is possible as a method for suppressing the absorption of liquids and mist into aerogel. On the other hand, according to such a method, thermal insulation performance tends to decrease due to the thermal conduction of the resin or the like. By contrast, according to the member with an aerogel layer of the present embodiment, the absorption of liquids and mist is suppressed while excellent thermal insulation properties can be possessed, because the barrier layer and the aerogel layer are each present alone.

The aerogel layer 4 may be in a form disposed on at least a portion (a portion or the whole) on the main body part 3. The barrier layer 5 may be in a form disposed on at least a portion (a portion or the whole) of the aerogel layer 4. In the member 1 with an aerogel layer, the aerogel layer 4 can be in a form integrally joined with the main body part 3. By this, thermal insulation performance can be imparted directly to the main body part 3. The barrier layer 5 can be in a form integrally joined with the aerogel layer 4. Specifically, the member 1 with an aerogel layer can be in a form where the aerogel layer 4 and the barrier layer 5 are integrally joined on the main body part 3 (e.g., a form where the main body part 3, the aerogel layer 4, and the barrier layer 5 are integrally fixed). Also, for example, an additional layer such as an intermediate layer may be further provided between the main body part 3 and the aerogel layer 4, or between the aerogel layer 4 and the barrier layer 5.

The aerogel layer 4 may comprise aerogel being a dried product of wet gel being a condensate of sol (wet gel derived from the sol) containing at least one selected from the group consisting of a silicon compound having a hydrolyzable functional group or a condensable functional group, and a hydrolysis product of the silicon compound having a hydrolyzable functional group (silicon compound in which the hydrolyzable functional group has been hydrolyzed). Specifically, the aerogel layer 4 may comprise aerogel prepared by drying wet gel produced from sol containing at least one selected from the group consisting of a silicon compound having a hydrolyzable functional group or a condensable functional group, and a hydrolysis product of the silicon compound having a hydrolyzable functional group. By this, thermal insulation properties, flame retardance and flexibility can be achieved at higher levels.

{Main Body Part}

Examples of the material constituting the main body part include metals, ceramics, glass, resins and composite materials thereof. The main body part may be in a form including at least one selected from the group consisting of, for example, metals, ceramics, glass and resins. A block form, a sheet form, a powder form, a spherical form, a fibrous form, or the like can be adopted as the form of the main body part according to the purpose or material used.

Examples of the metals include, but are not particularly limited to: simple substances of metals; alloys of metals; and metals with oxide layers formed. Examples of the metals include iron, copper, nickel, aluminum, zinc, titanium, chromium, cobalt, tin, gold, and silver. Depending on a material used in a sol production step mentioned later, simple substances of titanium, gold, silver, or the like, and iron and aluminum with an oxide layer formed can be used as the metals from the viewpoint of being excellent in the corrosion resistance of metal surface.

Examples of the ceramics include: oxides such as alumina, titania, zirconia, and magnesia; nitrides such as silicon nitride and aluminum nitride; carbides such as silicon carbide and boron carbide; and mixtures thereof.

Examples of the glass include quartz glass, soda glass, and borosilicate glass.

Examples of the resins include polyvinyl chloride, polyvinyl alcohol, polystyrene, polyethylene, polypropylene, polyacetal, polymethyl methacrylate, polycarbonate, polyamide, and polyurethane.

Adhesion can be further improved by using a main body part having large surface roughness, or a main body part having a porous structure. The surface roughness of the main body part may be, for example, 100 nm or larger, and may be 500 nm or larger, from the viewpoint that a good anchoring effect is obtained, and the adhesion of the aerogel layer further improves. An aspect in which the pores formed in the main body part having a porous structure are continuous holes, and the sum of pore volumes is 50 to 99% by volume of the total volume of the main body part is also acceptable from the viewpoint that thermal insulation properties improve more easily.

{Aerogel Layer}

The aerogel layer according to the present embodiment is one constituted by aerogel. Although dry gel obtained by using a supercritical drying method for wet gel is called aerogel; dry gel obtained by drying under atmospheric pressure is called xerogel; and dry gel obtained by freeze drying is called cryogel in the narrow sense, low-density dry gel obtained regardless of these drying approaches of wet gel is referred to as “aerogel” in the present embodiment. Specifically, in the present embodiment, the “aerogel” means “gel comprised of a microporous solid in which the dispersed phase is a gas” which is aerogel in the broad sense. In general, the inside of the aerogel has a network microstructure and has a cluster structure where aerogel particles (particles constituting the aerogel) on the order of 2 to 20 nm are bonded. Pores smaller than 100 nm reside between skeletons formed by this cluster. By this, the aerogel has a three-dimensionally fine and porous structure. The aerogel according to the present embodiment is, for example, silica aerogel composed mainly of silica. Examples of the silica aerogel include so-called organic-inorganic hybridized silica aerogel in which an organic group (a methyl group, etc.) or an organic chain is introduced. The aerogel layer may be a layer containing aerogel having a polysiloxane-derived structure.

The aerogel according to the present embodiment may be a dried product of wet gel being a condensate of sol containing at least one selected from the group consisting of a silicon compound having a hydrolyzable functional group or a condensable functional group (in the molecule), and a hydrolysis product of the silicon compound having a hydrolyzable functional group. Specifically, the aerogel according to the present embodiment may be one obtained by drying wet gel produced from sol containing at least one selected from the group consisting of a silicon compound having a hydrolyzable functional group or a condensable functional group (in the molecule), and a hydrolysis product of the silicon compound having a hydrolyzable functional group. The condensate may be obtained by the condensation reaction of a hydrolysis product obtained by the hydrolysis of the silicon compound having a hydrolyzable functional group, or may be obtained by the condensation reaction of the silicon compound having a condensable functional group which is not a functional group obtained by hydrolysis. The silicon compound can have at least one of the hydrolyzable functional group and the condensable functional group and may have both of the hydrolyzable functional group and the condensable functional group. Each aerogel mentioned later may be such a dried product of wet gel being a condensate of sol (one obtained by drying wet gel produced from the sol) containing at least one selected from the group consisting of a silicon compound having a hydrolyzable functional group or a condensable functional group, and a hydrolysis product of the silicon compound having a hydrolyzable functional group.

The aerogel layer may be a layer constituted by a dried product of wet gel being a condensate of sol containing at least one selected from the group consisting of a silicon compound having a hydrolyzable functional group or a condensable functional group, and a hydrolysis product of the silicon compound having a hydrolyzable functional group. Specifically, the aerogel layer may be constituted by a layer prepared by drying wet gel produced from sol containing at least one selected from the group consisting of a silicon compound having a hydrolyzable functional group or a condensable functional group, and a hydrolysis product of the silicon compound having a hydrolyzable functional group.

The aerogel according to the present embodiment can contain polysiloxane having a principal chain including a siloxane bond (Si—O—Si). The aerogel can have the following M unit, D unit, T unit or Q unit as a structural unit.

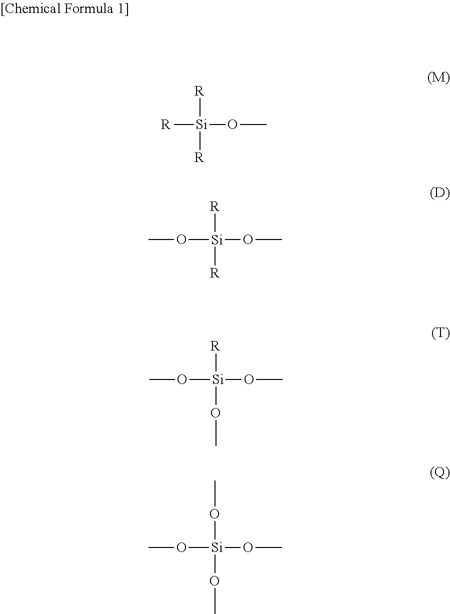

In the above formulas, R represents an atom (a hydrogen atom, etc.) or an atomic group (an alkyl group, etc.) bonded to the silicon atom. The M unit is a unit consisting of a monovalent group in which the silicon atom is bonded to one oxygen atom. The D unit is a unit consisting of a divalent group in which the silicon atom is bonded to two oxygen atoms. The T unit is a unit consisting of a trivalent group in which the silicon atom is bonded to three oxygen atoms. The Q unit is a unit consisting of a tetravalent group in which the silicon atom is bonded to four oxygen atoms. Information on the contents of these units can be obtained by Si-NMR.

The aerogel according to the present embodiment may contain silsesquioxane. The silsesquioxane is polysiloxane having the T unit as a structural unit, and has the composition formula: (RSiO_{1.5})ₙ. The silsesquioxane can have various skeletal structures such as cage type, ladder type, and random type.

Examples of the hydrolyzable functional group include alkoxy groups. Examples of the condensable functional group (except for functional groups corresponding to the hydrolyzable functional group) include a hydroxy group, silanol groups, a carboxyl group and a phenolic hydroxy group. The hydroxy group may be included in a hydroxy group-containing group such as a hydroxyalkyl group. Each of the hydrolyzable functional group and the condensable functional group may be used alone or by mixing two or more types.

The silicon compound may include a silicon compound having an alkoxy group as the hydrolyzable functional group, and can include a silicon compound having a hydroxyalkyl group as the condensable functional group. The silicon compound can have at least one selected from the group consisting of alkoxy groups, silanol groups, hydroxyalkyl groups and polyether groups from the viewpoint that the flexibility of the aerogel further improves. The silicon compound can have at least one selected from the group consisting of alkoxy groups and hydroxyalkyl groups from the viewpoint that the compatibility of sol improves.

The number of carbon atoms of each of the alkoxy groups and the hydroxyalkyl groups may be 1 to 6 from the viewpoint of improvement in the reactivity of the silicon compound and reduction in the thermal conductivity of the aerogel, and may be 2 to 4 from the viewpoint that the flexibility of the aerogel further improves. Examples of the alkoxy groups include a methoxy group, an ethoxy group, and a propoxy group. Examples of the hydroxyalkyl groups include a hydroxymethyl group, a hydroxyethyl group, and a hydroxypropyl group.

Examples of the aerogel according to the present embodiment include aspects given below. By adopting these aspects, it becomes easy to obtain aerogel excellent in thermal insulation properties, flame retardance, heat resistance and flexibility. Particularly, flexibility is excellent, whereby the thermal insulating layer can be more easily formed into even a shape heretofore difficult to form. By adopting each of the aspects, aerogel having thermal insulation properties, flame retardance and flexibility appropriate for each of the aspects can be obtained.

(First Aspect)

The aerogel according to the present embodiment may be a dried product of wet gel being a condensate of sol containing at least one compound selected from the group consisting of a polysiloxane compound having a hydrolyzable functional group or a condensable functional group (in the molecule), and a hydrolysis product of the polysiloxane compound having a hydrolyzable functional group (polysiloxane compound in which the hydrolyzable functional group has been hydrolyzed) (hereinafter, referred to as the “polysiloxane compound group” in some cases). Specifically, the aerogel according to the present embodiment may be one obtained by drying wet gel produced from sol containing at least one selected from the group consisting of a polysiloxane compound having a hydrolyzable functional group or a condensable functional group (in the molecule), and a hydrolysis product of the polysiloxane compound having a hydrolyzable functional group. Each aerogel mentioned later may also be such a dried product of wet gel being a condensate of sol (one obtained by drying wet gel produced from the sol) containing at least one selected from the group consisting of a polysiloxane compound having a hydrolyzable functional group or a condensable functional group, and a hydrolysis product of the polysiloxane compound having a hydrolyzable functional group.

The aerogel layer may be a layer constituted by a dried product of wet gel being a condensate of sol containing at least one selected from the group consisting of a polysiloxane compound having a hydrolyzable functional group or a condensable functional group, and a hydrolysis product of the polysiloxane compound having a hydrolyzable functional group. Specifically, the aerogel layer may be constituted by a layer prepared by drying wet gel produced from sol containing at least one selected from the group consisting of a polysiloxane compound having a hydrolyzable functional group or a condensable functional group, and a hydrolysis product of the polysiloxane compound having a hydrolyzable functional group.

The polysiloxane compound having a hydrolyzable functional group or a condensable functional group may further have a reactivity group different from the hydrolyzable functional group and the condensable functional group (functional group that corresponds neither to the hydrolyzable functional group nor to the condensable functional group). Examples of the reactivity group include, but are not particularly limited to, an epoxy group, a mercapto group, a glycidoxy group, a vinyl group, an acryloyl group, a methacryloyl group and an amino group. The epoxy group may be included in an epoxy group-containing group such as a glycidoxy group. The polysiloxane compound having the reactivity group may be used alone or by mixing two or more types.

Examples of the polysiloxane compound having a hydroxyalkyl group include a compound having a structure represented by the following formula (A).

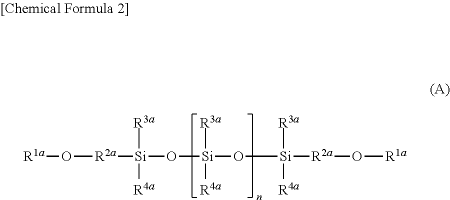

In the formula (A), R^{1a} represents a hydroxyalkyl group, R^{2a} represents an alkylene group, R^{3a} and R^{4a} each independently represent an alkyl group or an aryl group, and n represents an integer of 1 to 50. In this context, examples of the aryl group include a phenyl group and a substituted phenyl group. Examples of the substituent of the substituted phenyl group include alkyl groups, a vinyl group, a mercapto group, an amino group, a nitro group and a cyano group. In the formula (A), two R^{1a} may be the same as or different from each other, and likewise, two R^{2a} may be the same as or different from each other. In the formula (A), two or more R^{3a} may be the same as or different from each other, and likewise, two or more R^{4a} may be the same as or different from each other.

Aerogel that has low thermal conductivity and is flexible is more easily obtained by using wet gel being a condensate of sol (wet gel produced from the sol) containing a polysiloxane compound having the structure described above. From a similar viewpoint, features given below may be satisfied. In the formula (A), examples of R^{1a} include hydroxyalkyl groups having 1 to 6 carbon atoms and specifically include a hydroxyethyl group and a hydroxypropyl group. In the formula (A), examples of R^{2a} include alkylene groups having 1 to 6 carbon atoms and specifically include an ethylene group and a propylene group. In the formula (A), R^{3a} and R^{4a} may each independently be an alkyl group having 1 to 6 carbon atoms or a phenyl group. The alkyl group may be a methyl group. In the formula (A), n may be 2 to 30 and may be 5 to 20.

A commercially available product can be used as the polysiloxane compound having a structure represented by the above formula (A), and examples thereof include compounds such as X-22-160AS, KF-6001, KF-6002, and KF-6003 (all manufactured by Shin-Etsu Chemical Co., Ltd.), and compounds such as XF42-B0970 and Fluid OFOH 702-4% (all manufactured by Momentive Performance Materials Inc.).

Examples of the polysiloxane compound having an alkoxy group include a compound having a structure represented by the following formula (B).

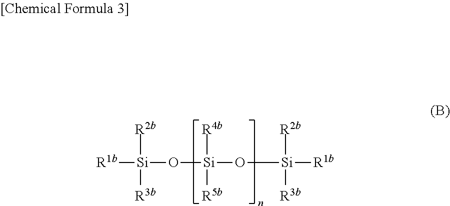

In the formula (B), R^{1b} represents an alkyl group, an alkoxy group or an aryl group, R^{2b} and R^{3b} each independently represent an alkoxy group, R^{4b} and R^{5b} each independently represent an alkyl group or an aryl group, and m represents an integer of 1 to 50. In this context, examples of the aryl group include a phenyl group and a substituted phenyl group. Examples of the substituent of the substituted phenyl group include alkyl groups, a vinyl group, a mercapto group, an amino group, a nitro group and a cyano group. In the formula (B), two R^{1b} may be the same as or different from each other, two R^{2b} may be the same as or different from each other, and likewise, two R^{3b} may be the same as or different from each other. In the formula (B), in the case where m is an integer of 2 or larger, two or more R^{4b} may be the same as or different from each other, and likewise, two or more R^{5b} may be the same as or different from each other.

Aerogel that has low thermal conductivity and is flexible is more easily obtained by using wet gel being a condensate of sol (wet gel produced from the sol) containing a polysiloxane compound having the structure described above or a hydrolysis product thereof. From a similar viewpoint, features given below may be satisfied. In the formula (B), examples of R^{1b} include alkyl groups having 1 to 6 carbon atoms and alkoxy groups having 1 to 6 carbon atoms and specifically include a methyl group, a methoxy group and an ethoxy group. In the formula (B), R^{2b} and R^{3b} may each independently be an alkoxy group having 1 to 6 carbon atoms. Examples of the alkoxy group include a methoxy group and an ethoxy group. In the formula (B), R^{4b} and R^{5b} may each independently be an alkyl group having 1 to 6 carbon atoms or a phenyl group. The alkyl group may be a methyl group. In the formula (B), m may be 2 to 30 and may be 5 to 20.

The polysiloxane compound having a structure represented by the above formula (B) can be obtained by appropriately referring to manufacturing methods reported in, for example, Japanese Unexamined Patent Publication No. 2000-26609 and Japanese Unexamined Patent Publication No. 2012-233110.

Since an alkoxy group hydrolyzes, there is a possibility that a polysiloxane compound having an alkoxy group exists as a hydrolysis product in sol, and the polysiloxane compound having an alkoxy group and a hydrolysis product thereof may coexist. Also, in the polysiloxane compound having an alkoxy group, all alkoxy groups in the molecule may be hydrolyzed or may be partially hydrolyzed.

Each of the polysiloxane compound having a hydrolyzable functional group or a condensable functional group, and the hydrolysis product of the polysiloxane compound having a hydrolyzable functional group may be used alone or by mixing two or more types.

The content of the polysiloxane compound group (the sum of the content of the polysiloxane compound having a hydrolyzable functional group or a condensable functional group, and the content of the hydrolysis product of the polysiloxane compound having a hydrolyzable functional group) contained in the sol may be 1 part by mass or more, may be 3 parts by mass or more, may be 4 parts by mass or more, may be 5 parts by mass or more, may be 7 parts by mass or more, and may be 10 parts by mass or more, with respect to 100 parts by mass in total of the sol from the viewpoint of more easily obtaining good reactivity. The content of the polysiloxane compound group may be 50 parts by mass or less, may be 30 parts by mass or less, and may be 15 parts by mass or less, with respect to 100 parts by mass in total of the sol from the viewpoint of more easily obtaining good compatibility. From these viewpoints, the content of the polysiloxane compound group may be 1 to 50 parts by mass, may be 3 to 50 parts by mass, may be 4 to 50 parts by mass, may be 5 to 50 parts by mass, may be 7 to 30 parts by mass, may be 10 to 30 parts by mass, and may be 10 to 15 parts by mass, with respect to 100 parts by mass in total of the sol.

[Second Aspect]

A silicon compound other than the polysiloxane compound may be used as the silicon compound having a hydrolyzable functional group or a condensable functional group. Specifically, the aerogel according to the present embodiment may be a dried product of wet gel being a condensate of sol containing at least one compound selected from the group consisting of a silicon compound (except for the polysiloxane compound) having a hydrolyzable functional group or a condensable functional group (in the molecule), and a hydrolysis product of the silicon compound having a hydrolyzable functional group (hereinafter, referred to as the “silicon compound group” in some cases). The number of silicon atoms in the molecule of the silicon compound may be 1 or 2.

Examples of the silicon compound having a hydrolyzable functional group include, but are not particularly limited to, alkyl silicon alkoxides. In the alkyl silicon alkoxide, the number of the hydrolyzable functional group may be 3 or less and may be 2 to 3, from the viewpoint that water resistance improves. Examples of the alkyl silicon alkoxides include monoalkyltrialkoxysilanes, monoalkyldialkoxysilanes, dialkyldialkoxysilanes, monoalkylmonoalkoxysilanes, dialkylmonoalkoxysilanes and trialkylmonoalkoxysilanes. Examples of the alkyl silicon alkoxide include methyltrimethoxysilane, methyldimethoxysilane, dimethyldimethoxysilane and ethyltrimethoxysilane.

Examples of the silicon compound having a condensable functional group include, but are not particularly limited to, silanetetraol, methylsilanetriol, dimethylsilanediol, phenylsilanetriol, phenylmethylsilanediol, diphenylsilanediol, n-propylsilanetriol, hexylsilanetriol, octylsilanetriol, decylsilanetriol and trifluoropropylsilanetriol.

Vinyltrimethoxysilane, 3-glycidoxypropyltrimethoxysilane, 3-glycidoxypropylmethyldimethoxysilane, 3-methacryloxypropyltrimethoxysilane, 3-methacryloxypropylmethyldimethoxysilane, 3-acryloxypropyltrimethoxysilane, 3-mercaptopropyltrimethoxysilane, 3-mercaptopropylmethyldimethoxysilane, N-phenyl-3-aminopropyltrimethoxysilane, N-2-(aminoethyl)-3-aminopropylmethyldimethoxysilane or the like can also be used as the silicon compound having three or less hydrolyzable functional groups and having a reactivity group.

Vinylsilanetriol, 3-glycidoxypropylsilanetriol, 3-glycidoxypropylmethylsilanediol, 3-methacryloxypropylsilanetriol, 3-methacryloxypropylmethylsilanediol, 3-acryloxypropylsilanetriol, 3-mercaptopropylsilanetriol, 3-mercaptopropylmethylsilanediol, N-phenyl-3-aminopropylsilanetriol, N-2-(aminoethyl)-3-aminopropylmethylsilanediol or the like can also be used as the silicon compound having a condensable functional group and having the reactivity group mentioned above.

Bistrimethoxysilylmethane, bistrimethoxysilylethane, bistrimethoxysilylhexane or the like, which is a silicon compound having more than 3 hydrolyzable functional groups at the molecular end, can also be used as the alkyl silicon alkoxide.

Each of the silicon compound (except for the polysiloxane compound) having a hydrolyzable functional group or a condensable functional group, and the hydrolysis product of the silicon compound having a hydrolyzable functional group may be used alone or by mixing two or more types.

The content of the silicon compound group (the sum of the content of the silicon compound (except for the polysiloxane compound) having a hydrolyzable functional group or a condensable functional group, and the content of the hydrolysis product of the silicon compound having a hydrolyzable functional group) contained in the sol can be 5 parts by mass or more, may be 10 parts by mass or more, may be 12 parts by mass or more, may be 15 parts by mass or more, and may be 18 parts by mass or more, with respect to 100 parts by mass in total of the sol because of more easily obtaining good reactivity. The content of the silicon compound group can be 50 parts by mass or less, may be 30 parts by mass or less, may be 25 parts by mass or less, and may be 20 parts by mass or less, with respect to 100 parts by mass in total of the sol because of more easily obtaining good compatibility. Specifically, the content of the silicon compound group can be 5 to 50 parts by mass, may be 10 to 30 parts by mass, may be 12 to 30 parts by mass, may be 15 to 25 parts by mass, and may be 18 to 20 parts by mass, with respect to 100 parts by mass in total of the sol.

The sum of the content of the polysiloxane compound group and the content of the silicon compound group may be 5 parts by mass or more, may be 10 parts by mass or more, may be 15 parts by mass or more, may be 20 parts by mass or more, and may be 22 parts by mass or more, with respect to 100 parts by mass in total of the sol from the viewpoint of more easily obtaining good reactivity. The sum of the content of the polysiloxane compound group and the content of the silicon compound group may be 50 parts by mass or less, may be 30 parts by mass or less, and may be 25 parts by mass or less, with respect to 100 parts by mass in total of the sol from the viewpoint of more easily obtaining good compatibility. From these viewpoints, the sum of the content of the polysiloxane compound group and the content of the silicon compound group may be 5 to 50 parts by mass, may be 10 to 30 parts by mass, may be 15 to 30 parts by mass, may be 20 to 30 parts by mass, and may be 22 to 25 parts by mass, with respect to 100 parts by mass in total of the sol.

The ratio between the content of the polysiloxane compound group and the content of the silicon compound group (polysiloxane compound group:silicon compound group) may be 1:0.5 or more, may be 1:1 or more, may be 1:2 or more, and may be 1:3 or more, from the viewpoint of more easily obtaining good compatibility. The ratio between the content of the polysiloxane compound group and the content of the silicon compound group (polysiloxane compound group:silicon compound group) may be 1:4 or less and may be 1:2 or less, from the viewpoint of more easily suppressing the shrinkage of gel. From these viewpoints, the ratio between the content of the polysiloxane compound group and the content of the silicon compound group (polysiloxane compound group:silicon compound group) may be 1:0.5 to 1:4, may be 1:1 to 1:2, may be 1:2 to 1:4, and may be 1:3 to 1:4.

[Third Aspect]

The aerogel according to the present embodiment can have a structure represented by the following formula (1). The aerogel according to the present embodiment can have a structure represented by the following formula (1a) as a structure including the structure represented by the formula (1). The structures represented by the formula (1) and the formula (1a) can be introduced into the skeleton of the aerogel by using the polysiloxane compound having a structure represented by the above formula (A).

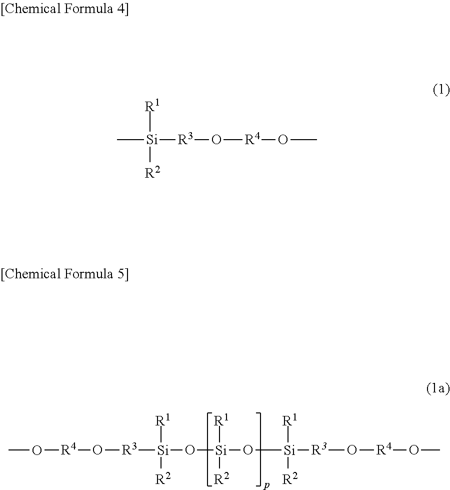

In the formula (1) and the formula (1a), R¹ and R² each independently represent an alkyl group or an aryl group, and R³ and R⁴ each independently represent an alkylene group. In this context, examples of the aryl group include a phenyl group and a substituted phenyl group. Examples of the substituent of the substituted phenyl group include alkyl groups, a vinyl group, a mercapto group, an amino group, a nitro group and a cyano group. p represents an integer of 1 to 50. In the formula (1a), two or more R¹ may be the same as or different from each other, and likewise, two or more R² may be the same as or different from each other. In the formula (1a), two R³ may be the same as or different from each other, and likewise, two R⁴ may be the same as or different from each other.

Aerogel that has low thermal conductivity and is flexible can be easily obtained by introducing the structure represented by the above formula (1) or formula (1a) into the skeleton of the aerogel. From a similar viewpoint, features given below may be satisfied. In the formula (1) and the formula (1a), R¹ and R² may each independently be an alkyl group having 1 to 6 carbon atoms or a phenyl group. The alkyl group may be a methyl group. In the formula (1) and the formula (1a), R³ and R⁴ may each independently be an alkylene group having 1 to 6 carbon atoms. The alkylene group may be an ethylene group or a propylene group. In the formula (1a), p can be set to 2 to 30 and may be 5 to 20.

[Fourth Aspect]

The aerogel according to the present embodiment may be aerogel having a ladder-type structure having struts and bridges, wherein the bridges have a structure represented by the following formula (2). Heat resistance and mechanical strength can be easily improved by introducing such a ladder-type structure into the skeleton of the aerogel. The ladder-type structure including the bridges having a structure represented by the formula (2) can be introduced into the skeleton of the aerogel by using the polysiloxane compound having a structure represented by the above formula (B). In the present embodiment, the “ladder-type structure” is a structure having two struts and bridges connecting the struts (structure having the form of a so-called “ladder”). In this aspect, the aerogel skeleton may consist of a ladder-type structure, or the aerogel may partially have a ladder-type structure.

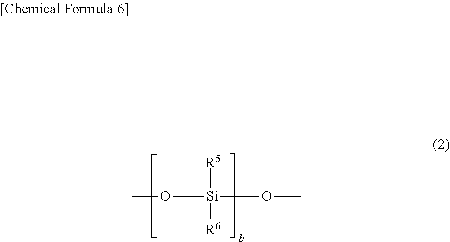

In the formula (2), R⁵ and R⁶ each independently represent an alkyl group or an aryl group, and b represents an integer of 1 to 50. In this context, examples of the aryl group include a phenyl group and a substituted phenyl group. Examples of the substituent of the substituted phenyl group include alkyl groups, a vinyl group, a mercapto group, an amino group, a nitro group and a cyano group. In the formula (2), in the case where b is an integer of 2 or larger, two or more R⁵ may be the same as or different from each other, and likewise, two or more R⁶ may be the same as or different from each other.

For example, aerogel having better flexibility than that of conventional aerogel having a structure derived from ladder-type silsesquioxane (i.e., having a structure represented by the following formula (X)) is prepared by introducing the structure described above into the skeleton of the aerogel. As shown in the following formula (X), the structure of the bridges in the conventional aerogel having a structure derived from ladder-type silsesquioxane is —O—, whereas the structure of the bridges in the aerogel of this aspect is a structure represented by the above formula (2) (polysiloxane structure).

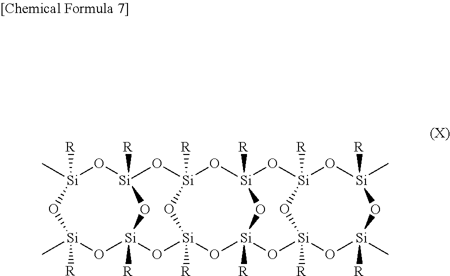

In the formula (X), R represents a hydroxy group, an alkyl group or an aryl group.

Although the structures serving as the struts and the chain length thereof, and the intervals between the structures serving as the bridges are not particularly limited, a ladder-type structure represented by the following formula (3) may be contained as the ladder-type structure from the viewpoint of further improving heat resistance and mechanical strength.

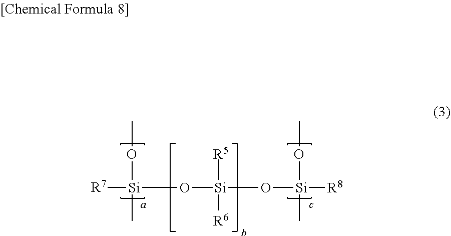

In the formula (3), R⁵, R⁶, R⁷ and R⁸ each independently represent an alkyl group or an aryl group, a and c each independently represent an integer of 1 to 3000, and b represents an integer of 1 to 50. In this context, examples of the aryl group include a phenyl group and a substituted phenyl group. Examples of the substituent of the substituted phenyl group include alkyl groups, a vinyl group, a mercapto group, an amino group, a nitro group and a cyano group. In the formula (3), in the case where b is an integer of 2 or larger, two or more R⁵ may be the same as or different from each other, and likewise, two or more R⁶ may be the same as or different from each other. In the formula (3), in the case where a is an integer of 2 or larger, two or more R⁷ may be the same as or different from each other. In the formula (3), in the case where c is an integer of 2 or larger, two or more R⁸ may be the same as or different from each other.

In the formula (2) and the formula (3), R⁵, R⁶, R⁷ and R⁸ (however, R⁷ and R⁸ are only in the formula (3)) may each independently be an alkyl group having 1 to 6 carbon atoms or a phenyl group from the viewpoint of obtaining much better flexibility. The alkyl group may be a methyl group. In the formula (3), a and c may each independently be 6 to 2000 and may each independently be 10 to 1000. In the formula (2) and the formula (3), b may be 2 to 30 and may be 5 to 20.

[Fifth Aspect]

The aerogel according to the present embodiment may contain silica particles from the viewpoint of achieving much better thermal insulation properties and flexibility. The sol that yields the aerogel may further contain silica particles. Specifically, the aerogel according to the present embodiment may be a dried product of wet gel being a condensate of sol (one obtained by drying wet gel produced from the sol) containing silica particles. Specifically, the aerogel layer according to the present embodiment may comprise aerogel being a dried product of wet gel being a condensate of sol (wet gel derived from the sol) (one obtained by drying wet gel produced from the sol) containing silica particles. The aerogel layer may be a layer constituted by a dried product of wet gel being a condensate of sol containing silica particles, and the aerogel layer may be constituted by a layer prepared by drying wet gel produced from sol containing silica particles. The aerogel mentioned above may also be such a dried product of wet gel being a condensate of sol (one obtained by drying wet gel produced from the sol) containing silica particles.

The silica particles can be used without particular limitations, and examples thereof include amorphous silica particles. Examples of the amorphous silica particles include fused silica particles, fumed silica particles and colloidal silica particles. Among these, the colloidal silica particles are highly monodisperse and are easily prevented from aggregating in the sol.

Examples of the shape of the silica particles include, but are not particularly limited to, a spherical shape, cocoon type, and associated type. Among these, spherical particles are used as the silica particles and are thereby easily prevented from aggregating in the sol. The average primary particle diameter of the silica particles may be 1 nm or larger, may be 5 nm or larger, may be 10 nm or larger, and may be 20 nm or larger, from the viewpoint of easily imparting moderate strength and flexibility to the aerogel and easily obtaining aerogel excellent in shrinkage resistance at the time of drying. The average primary particle diameter of the silica particles may be 500 nm or smaller, may be 300 nm or smaller, may be 250 nm or smaller, and may be 100 nm or smaller, from the viewpoint of easily suppressing the solid heat conduction of the silica particles and easily obtaining aerogel excellent in thermal insulation properties. From these viewpoints, the average primary particle diameter of the silica particles may be 1 to 500 nm, may be 5 to 300 nm, may be 10 to 250 nm, and may be 20 to 100 nm.

In the present embodiment, the average particle diameter of particles (the average primary particle diameter of the silica particles, etc.) can be obtained by directly observing the cross-section of the aerogel layer under a scanning electron microscope (hereinafter, abbreviated to “SEM”). For example, from the network microstructure in the inside of the aerogel, the individual particle diameters of the aerogel particles or the silica particles can be obtained on the basis of the diameters of particles exposed on the cross-section of the aerogel layer. In this context, the “diameter” means a diameter in the case of regarding the cross-section of a particle exposed on the cross-section of the aerogel layer as a circle. Also, the “diameter in the case of regarding the cross-section as a circle” is the diameter of a true circle when the area of the cross-section is replaced with the true circle having the same area. For the calculation of the average particle diameter, the diameter of a circle is determined as to 100 particles, and the average thereof is taken.

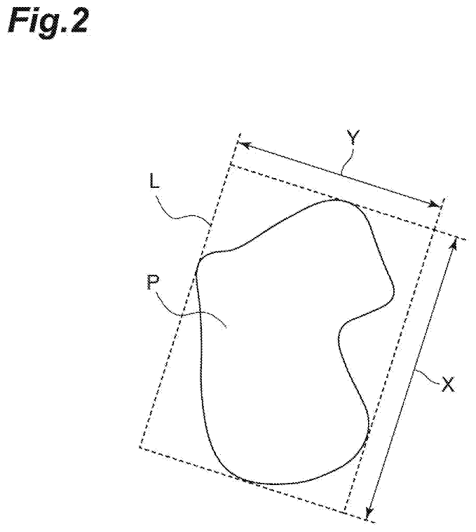

The average particle diameter of the silica particles can be measured from the raw material. For example, the two-axis average primary particle diameter is calculated as follows from results of observing 20 arbitrary particles by SEM. Specifically, when colloidal silica particles having a solid concentration of 5 to 40% by mass, which are usually dispersed in water, are taken as an example, a chip obtained by cutting a patterned wafer into 2 cm square is dipped in the dispersion of the colloidal silica particles for approximately 30 seconds, and then, the chip is rinsed with pure water for approximately 30 seconds and dried by nitrogen blow. Then, the chip is placed on a sample table for SEM observation, and the silica particles are observed at a magnification of ×100000 by applying accelerating voltage of 10 kV, followed by photographing. Twenty silica particles are arbitrarily selected from the obtained image, and the average of the particle diameters of these particles is regarded as the average particle diameter. In this respect, in the case where the selected silica particles have a shape as shown in FIG. 2, a rectangle that circumscribes silica particle P and is positioned such that its long side becomes longest (bounding rectangle L) is drawn. Then, when the long side of the bounding rectangle L is defined as X, and the short side is defined as Y, the two-axis average primary particle diameter is calculated as (X+Y)/2 and regarded as the particle diameter of the particle.

The number of silanol groups per g of the silica particles may be 10×10¹⁸ groups/g or more, may be 50×10¹⁸ groups/g or more, and may be 100×10¹⁸ groups/g or more, from the viewpoint of easily obtaining aerogel excellent in shrinkage resistance. The number of silanol groups per g of the silica particles may be 1000×10¹⁸ groups/g or less, may be 800×10¹⁸ groups/g or less, and may be 700×10¹⁸ groups/g or less, from the viewpoint that homogeneous aerogel is easily obtained. From these viewpoints, the number of silanol groups per g of the silica particles may be 10×10¹⁸ to 1000×10¹⁸ groups/g, may be 50×10¹⁸ to 800×10¹⁸ groups/g, and may be 100×10¹⁸ to 700×10¹⁸ groups/g.

The content of the silica particles contained in the sol may be 1 part by mass or more and may be 4 parts by mass or more, with respect to 100 parts by mass in total of the sol from the viewpoint of easily imparting moderate strength to the aerogel and easily obtaining aerogel excellent in shrinkage resistance at the time of drying. The content of the silica particles contained in the sol may be 20 parts by mass or less, may be 15 parts by mass or less, may be 12 parts by mass or less, may be 10 parts by mass or less, and may be 8 parts by mass or less, with respect to 100 parts by mass in total of the sol from the viewpoint of easily suppressing the solid heat conduction of the silica particles and easily obtaining aerogel excellent in thermal insulation properties. From these viewpoints, the content of the silica particles contained in the sol may be 1 to 20 parts by mass, may be 4 to 15 parts by mass, may be 4 to 12 parts by mass, may be 4 to 10 parts by mass, and may be 4 to 8 parts by mass, with respect to 100 parts by mass in total of the sol.

[Other Aspects]

The aerogel according to the present embodiment can have a structure represented by the following formula (4). The aerogel according to the present embodiment can contain silica particles and also have a structure represented by the following formula (4).

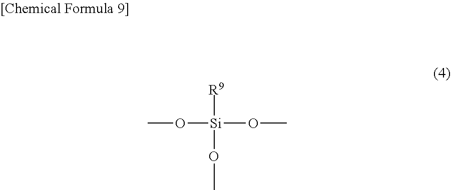

In the formula (4), R⁹ represents an alkyl group. Examples of the alkyl group include alkyl groups having 1 to 6 carbon atoms and specifically include a methyl group.

The aerogel according to the present embodiment can have a structure represented by the following formula (5). The aerogel according to the present embodiment can contain silica particles and also have a structure represented by the following formula (5).

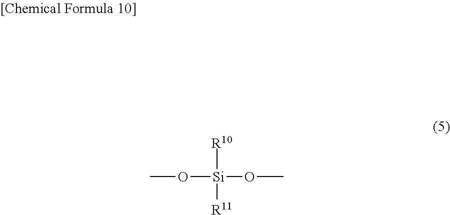

In the formula (5), R¹⁰ and R¹¹ each independently represent an alkyl group. Examples of the alkyl group include alkyl groups having 1 to 6 carbon atoms and specifically include a methyl group.

The aerogel according to the present embodiment can have a structure represented by the following formula (6). The aerogel according to the present embodiment can contain silica particles and also have a structure represented by the following formula (6).

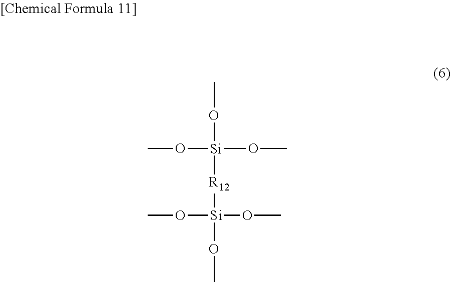

In the formula (6), R¹² represents an alkylene group. Examples of the alkylene group include alkylene groups having 1 to 10 carbon atoms and specifically include an ethylene group and a hexylene group.

The aerogel according to the present embodiment may have a polysiloxane-derived structure. Specifically, the aerogel layer according to the present embodiment may be constituted by a layer containing aerogel having a polysiloxane-derived structure. Examples of the polysiloxane-derived structure include a structure represented by the above formula (1), (2), (3), (4), (5) or (6). The aerogel according to the present embodiment may have at least one of the structures represented by the above formulas (4), (5) and (6) without containing silica particles.

The thickness of the aerogel layer may be 1 μm or larger, may be 10 μm or larger, and may be 30 μm or larger, because of easily obtaining good thermal insulation properties. The thickness of the aerogel layer may be 1000 μm or smaller, may be 200 μm or smaller, and may be 100 μm or smaller, from the viewpoint that the times of a washing and solvent replacement step and a drying step mentioned later can be shortened. From these viewpoints, the thickness of the aerogel layer may be 1 to 1000 μm, may be 10 to 200 μm, and may be 30 to 100 μm.

{Barrier Layer}

The barrier layer contains a siloxane compound, as mentioned above. The siloxane compound is a compound having a siloxane bond (Si—O—Si bond). Examples of the siloxane compound include polymers and oligomers having a siloxane bond (Si—O—Si bond). Specific examples of the siloxane compound include silicone (silicon resin), condensates of organosilicon compounds having a hydrolyzable functional group, and silicone-modified polymers. Examples of the organosilicon compounds having a hydrolyzable functional group include methyltrimethoxysilane, dimethyldimethoxysilane and trimethylmethoxysilane. The siloxane compound may be, for example, silicone or a condensate of methyltrimethoxysilane from the viewpoint of bonding strength with the aerogel layer, heat resistance, etc.

The barrier layer may further contain, for example, a filler. Examples of the material constituting the filler include metals and ceramics. Examples of the metals include: simple substances of metals; alloys of metals; and metals with oxide layers formed. Examples of the metals include iron, copper, nickel, aluminum, zinc, titanium, chromium, cobalt, tin, gold, and silver. Examples of the ceramics include: oxides such as alumina, titania, zirconia, and magnesia; nitrides such as silicon nitride and aluminum nitride; carbides such as silicon carbide and boron carbide; and mixtures thereof. The material constituting the filler may be, for example, fused silica, fumed silica, colloidal silica, hollow silica, glass, or scaly silica. Examples of the glass include quartz glass, soda glass, and borosilicate glass.

The content of the siloxane compound in the barrier layer may be, for example, 20% by volume or more, may be 30% by volume or more, and may be 40% by volume or more, with respect to the total volume of the barrier layer from the viewpoint of easily obtaining a dense barrier layer derived from the skeleton of the siloxane compound. The content of the siloxane compound may be, for example, 80% by volume or less, may be 70% by volume or less, and may be 60% by volume or less, with respect to the total volume of the barrier layer from the viewpoint of improvement in workability for barrier layer formation. In the case where the barrier layer contains a filler, the content of the filler in the barrier layer may be, for example, 0.1% by volume or more, may be 1% by volume or more, and may be 5% by volume or more, with respect to the total volume of the barrier layer from the viewpoint of the suppression of the penetration of a barrier layer composition into the aerogel layer and improvement in heat resistance.

The thickness of the barrier layer may be, for example, 1 μm or larger, may be 5 m or larger, and may be 10 μm or larger, from the viewpoint that oil resistance further improves. The thickness of the barrier layer may be, for example, 1000 μm or smaller, may be 200 μm or smaller, and may be 100 μm or smaller, from the viewpoint of improvement in handleability after barrier layer formation. The total thickness of the aerogel layer and the barrier layer may be, for example, 2 m or larger, may be 15 m or larger, and may be 40 μm or larger, from the viewpoint of obtaining better thermal insulation properties and oil resistance. The total thickness of the aerogel layer and the barrier layer may be, for example, 2000 m or smaller, may be 400 m or smaller, and may be 200 μm or smaller, from the viewpoint of the shortening of production process times, improvement in handleability, etc.

<Method for Manufacturing Member with Aerogel Layer>

Next, the method for manufacturing a member with an aerogel layer will be described. Although the method for manufacturing a member with an aerogel layer is not particularly limited, the manufacture can be performed by, for example, the following method.

The member with an aerogel layer of the present embodiment can be manufactured by, for example, a method comprising: a step of forming an aerogel layer on a main body part (aerogel layer formation step); and a step of forming a barrier layer on the aerogel layer (barrier layer formation step).

{Aerogel Layer Formation Step}

The aerogel layer formation step can mainly comprise, for example: a sol production step of producing sol for forming aerogel; a sol coating film formation step of coating a main body part with a sol coating liquid containing the sol to form a sol coating film; a wet gel production step of producing wet gel from the sol coating film; a step of subjecting the wet gel to washing and (if necessary) solvent replacement; and a drying step of drying the washed and solvent-replaced wet gel. The sol refers to a state before gelling reaction occurs. In the present embodiment, it means, for example, a state where a silicon compound (if necessary, further, silica particles) is dissolved or dispersed in a solvent. Also, the wet gel means gel solid matter in a wet state lacking fluidity, through containing a liquid medium.

Hereinafter, each step of the aerogel layer formation step will be described.

(Sol Production Step)

In the sol production step, for example, a silicon compound (if necessary, further, silica particles) is mixed with a solvent and hydrolyzed to produce sol. In this step, an acid catalyst may be further added in order to accelerate the hydrolysis reaction. Also, as shown in Japanese Patent No. 5250900, a surfactant, a thermally hydrolyzable compound or the like can also be added. Further, a component such as carbon graphite, an aluminum compound, a magnesium compound, a silver compound, or a titanium compound may be added for the purpose of suppression of heat radiation, etc.

For example, water or a mixed solution of water and an alcohol can be used as the solvent. Examples of the alcohol include methanol, ethanol, n-propanol, 2-propanol, n-butanol, 2-butanol and t-butanol. Among these, examples of the alcohol having low surface tension and a low boiling point include methanol, ethanol, and 2-propanol, from the viewpoint of reducing surface tension with a gel wall. These may be used alone or by mixing two or more types.

In the case of using, for example, an alcohol as the solvent, the amount of the alcohol may be, for example, 4 to 8 mol, may be 4 to 6.5, and may be 4.5 to 6 mol, with respect to 1 mol in total of the silicon compound and the polysiloxane compound. The amount of the alcohol is set to 4 mol or more, whereby good compatibility is more easily obtained; and it is set to 8 mol or less, whereby the shrinkage of gel is more easily suppressed.

Examples of the acid catalyst include: inorganic acids such as hydrofluoric acid, hydrochloric acid, nitric acid, sulfuric acid, sulfurous acid, phosphoric acid, phosphorous acid, hypophosphorous acid, bromic acid, chloric acid, chlorous acid, and hypochlorous acid; acidic phosphates such as acidic aluminum phosphate, acidic magnesium phosphate, and acidic zinc phosphate; and organic carboxylic acids such as acetic acid, formic acid, propionic acid, oxalic acid, malonic acid, succinic acid, citric acid, malic acid, adipic acid, and azelaic acid. Among these, examples of the acid catalyst further improving the water resistance of the resulting aerogel layer include organic carboxylic acids. Examples of the organic carboxylic acids include acetic acid, but may be formic acid, propionic acid, oxalic acid, malonic acid, and the like. These may be used alone or by mixing two or more types.

The sol can be obtained in a shorter time by using the acid catalyst and thereby accelerating the hydrolysis reaction of the silicon compound.

The amount of the acid catalyst added can be, for example, 0.001 to 0.1 parts by mass with respect to 100 parts by mass in total of the silicon compound.

A nonionic surfactant, an ionic surfactant or the like can be used as the surfactant. These may be used alone or by mixing two or more types.

For example, one including a hydrophilic moiety such as polyoxyethylene and a hydrophobic moiety consisting mainly of an alkyl group, or one including a hydrophilic moiety such as polyoxypropylene can be used as the nonionic surfactant. Examples of the one including a hydrophilic moiety such as polyoxyethylene and a hydrophobic moiety consisting mainly of an alkyl group include polyoxyethylene nonyl phenyl ether, polyoxyethylene octyl phenyl ether, and polyoxyethylene alkyl ethers. Examples of the one including a hydrophilic moiety such as polyoxypropylene include polyoxypropylene alkyl ethers and block copolymers of polyoxyethylene and polyoxypropylene.

Examples of the ionic surfactant include a cationic surfactant, an anionic surfactant, and an amphoteric surfactant. Examples of the cationic surfactant include cetyl trimethyl ammonium bromide, cetyl trimethyl ammonium chloride, and examples of the anionic surfactant include sodium dodecylsulfonate. Further, examples of the amphoteric surfactant include amino acid-based surfactants and betaine-based surfactants and amine oxide-based surfactants. Examples of the amino acid-based surfactants include acylglutamic acid. Examples of the betaine-based surfactants include lauryl dimethylaminoacetic acid betaine and stearyl dimethylaminoacetic acid betaine. Examples of the amine oxide-based surfactants include lauryl dimethylamine oxide.

These surfactants are considered, in the wet gel production step, to have the effect of decreasing the difference in chemical affinity between the solvent in the reaction system and a growing siloxane polymer, and suppressing phase separation.

The amount of the surfactant added may be, for example, 1 to 100 parts by mass and may be 5 to 60 parts by mass, with respect to 100 parts by mass in total of the silicon compound, though also depending on the type of the surfactant, or the type and amount of the silicon compound.

It is considered that the thermally hydrolyzable compound generates a base catalyst by thermal hydrolysis so that the reaction solution is rendered basic to accelerate the sol-gel reaction in the wet gel production step. Accordingly, this thermally hydrolyzable compound is not particularly limited as long as being a compound that can render the reaction solution basic after hydrolysis, and examples thereof can include: urea; acid amides such as formamide, N-methylformamide, N,N-dimethylformamide, acetamide, N-methylacetamide, and N,N-dimethylacetamide; and cyclic nitrogen compounds such as hexamethylenetetramine. Among these, particularly, urea is more likely to produce the accelerating effect described above.

The amount of the thermally hydrolyzable compound added is not particularly limited as long as being an amount that can sufficiently accelerate the sol-gel reaction in the wet gel production step. For example, the amount of the thermally hydrolyzable compound (urea, etc.) added may be, for example, 1 to 200 parts by mass and may be 2 to 150 parts by mass, with respect to 100 parts by mass in total of the silicon compound. The amount added is set to 1 part by mass or more, whereby good reactivity is more easily obtained; and it is set to 200 parts by mass or less, whereby the deposition of crystals and decrease in gel density are more easily suppressed.

The hydrolysis in the sol production step may be performed, for example, for 10 minutes to 24 hours in a temperature environment of 20 to 60° C., and may be performed for 5 minutes to 8 hours in a temperature environment of 50 to 60° C., though also depending on the types and amounts of the silicon compound, the silica particles, the acid catalyst, the surfactant, etc. in the mixed solution. By this, the hydrolyzable functional group in the silicon compound is sufficiently hydrolyzed so that a hydrolysis product of the silicon compound can be more reliably obtained.

In the case of adding the thermally hydrolyzable compound into the solvent, the temperature environment in the sol production step may be adjusted to a temperature that suppresses the hydrolysis of the thermally hydrolyzable compound and suppresses the gelling of the sol. The temperature at this time may be any temperature as long as being a temperature that can suppress the hydrolysis of the thermally hydrolyzable compound. For example, in the case of using urea as the thermally hydrolyzable compound, the temperature environment in the sol production step may be 0 to 40° C. and may be 10 to 30° C.

(Sol Coating Film Formation Step)

The sol coating film formation step is a step of coating a main body part with a sol coating liquid containing the sol to form a sol coating film. The sol coating liquid may be in a form consisting of the sol. Alternatively, the sol coating liquid may be one in which the sol has been gelled (semi-gelled) to an extent having fluidity. The sol coating liquid may contain, for example, a base catalyst in order to accelerate gelling.

Examples of the base catalyst include: alkali metal hydroxides such as lithium hydroxide, sodium hydroxide, potassium hydroxide, and cesium hydroxide; ammonium compounds such as ammonium hydroxide, ammonium fluoride, ammonium chloride, and ammonium bromide; basic phosphoric acid sodium salts such as sodium metaphosphate, sodium pyrophosphate, and sodium polyphosphate; aliphatic amines such as allylamine, diallylamine, triallylamine, isopropylamine, diisopropylamine, ethylamine, diethylamine, triethylamine, 2-ethylhexylamine, 3-ethoxypropylamine, diisobutylamine, 3-(diethylamino)propylamine, di-2-ethylhexylamine, 3-(dibutylamino)propylamine, tetramethylethylenediamine, t-butylamine, sec-butylamine, propylamine, 3-(methylamino)propylamine, 3-(dimethylamino)propylamine, 3-methoxyamine, dimethylethanolamine, methyldiethanolamine, diethanolamine, and triethanolamine; and nitrogen-containing heterocyclic compounds such as morpholine, N-methylmorpholine, 2-methylmorpholine, piperazine and derivatives thereof, piperidine and derivatives thereof, and imidazole and derivatives thereof. Among these, ammonium hydroxide (ammonia water) is excellent from the viewpoint of not impairing water resistance because of being highly volatile and being less likely to remain in the aerogel layer after drying, and further from the viewpoint of economic efficiency. The base catalyst may be used alone or by mixing two or more types.

The dehydration condensation reaction, dealcoholization condensation reaction, or both the reactions of the silicon compound (polysiloxane compound group and silicon compound group) and the silica particles in the sol can be accelerated, and the gelling of the sol can be performed in a shorter time, by using the base catalyst. By this, wet gel having higher strength (rigidity) can be obtained. Particularly, since ammonia is highly volatile and is less likely to remain in the aerogel layer, an aerogel layer having much better water resistance can be obtained by using ammonia as the base catalyst.

The amount of the base catalyst added may be, for example, 0.5 to 5 parts by mass and may be 1 to 4 parts by mass, with respect to 100 parts by mass in total of the silicon compound (polysiloxane compound group and silicon compound group). The amount added is set to 0.5 parts by mass or more, whereby the gelling can be performed in a shorter time; and it is set to 5 parts by mass or less, whereby reduction in water resistance can be further suppressed.

In the case of semi-gelling the sol, the gelling may be performed in a closed vessel such that the solvent and the base catalyst do not volatilize. The gelling temperature in this case may be, for example, 30 to 90° C. and may be 40 to 80° C. The gelling temperature is set to 30° C. or higher, whereby the gelling can be performed in a shorter time. Also, the gelling temperature is set to 90° C. or lower, whereby the gelling can be performed with volumetric shrinkage suppressed because the volatilization of the solvent (particularly, an alcohol) is easily suppressed.

Although the gelling time in the case of semi-gelling the sol differs depending on the gelling temperature, the gelling time can be shortened, as compared with sol applied to conventional aerogel, in the case of containing silica particles in the sol. The reason for this is presumed to be that the hydrolyzable functional group or the condensable functional group carried by the silicon compound in the sol forms a hydrogen bond or a chemical bond with the silanol groups of the silica particles. The gelling time may be, for example, 10 to 360 minutes and may be 20 to 180 minutes. The gelling time is 10 minutes or longer, whereby the viscosity of the sol improves moderately, and the coatability of the main body part improves; and it is 360 minutes or shorter, whereby the sol is easily prevented from being completely gelled, and good bonding strength with the main body part is easily obtained.

Examples of the method for coating the main body part with the sol coating liquid include, but are not particularly limited to, dip coating, spray coating, spin coating, and roll coating.

(Wet Gel Production Step)

The wet gel production step is, for example, a step of producing wet gel from the sol coating film. In the wet gel production step, for example, the sol coating film is gelled by heating the sol coating film, and the obtained gel is then aged, if necessary, to produce wet gel. The wet gel production step may be performed in a closed vessel such that the solvent and the base catalyst do not volatilize. When the gel is aged in the wet gel production step, the bond of the components constituting the wet gel is strengthened, and as a result, wet gel having strength (rigidity) high enough to suppress shrinkage during drying is easily obtained. The heating temperature and the aging temperature in the wet gel production step may be, for example, 30 to 90° C. and may be 40 to 80° C. The heating temperature or the aging temperature is set to 30° C. or higher, whereby wet gel having higher strength (rigidity) can be obtained; and the heating temperature or the aging temperature is set to 90° C. or lower, whereby the gelling can be performed with volumetric shrinkage suppressed because the volatilization of the solvent (particularly, an alcohol) is easily suppressed.

(Washing and Solvent Replacement Step)

The washing and solvent replacement step is a step having a step of washing the wet gel obtained by the wet gel production step (washing step), and a step of replacing washes in the wet gel with a suitable solvent for drying conditions (drying step mentioned later) (solvent replacement step). Although the washing and solvent replacement step may be carried out in a mode of performing only the solvent replacement step without performing the step of washing the wet gel, the wet gel may be washed from the viewpoint of reducing impurities such as unreacted products and by-products in the wet gel, and permitting manufacture of an aerogel layer having higher purity. In the case where silica particles are contained in the gel, the solvent replacement step is not always essential as mentioned later.

In the washing step, the wet gel obtained in the wet gel production step is washed. The washing can be repetitively performed by using, for example, water or an organic solvent. In this respect, washing efficiency can be improved by warming.

Various organic solvents such as methanol, ethanol, 1-propanol, 2-propanol, 1-butanol, acetone, methyl ethyl ketone, 1,2-dimethoxyethane, acetonitrile, hexane, toluene, diethyl ether, chloroform, ethyl acetate, tetrahydrofuran, methylene chloride, N,N-dimethylformamide, dimethyl sulfoxide, acetic acid, and formic acid can be used as the organic solvent. The organic solvent may be used alone or by mixing two or more types.

In the solvent replacement step mentioned later, a solvent having low surface tension can be used for suppressing the shrinkage of the gel caused by drying. However, the solvent having low surface tension generally has very low mutual solubility in water. Therefore, in the case of using the solvent having low surface tension in the solvent replacement step, examples of the organic solvent used in the washing step include hydrophilic organic solvents having high mutual solubility in both of water and the solvent having low surface tension. The hydrophilic organic solvent used in the washing step can play a role in preliminary replacement for the solvent replacement step. Among the organic solvents described above, examples of the hydrophilic organic solvents include methanol, ethanol, 2-propanol, acetone and methyl ethyl ketone. Methanol, ethanol, methyl ethyl ketone, or the like is excellent in economic efficiency.

The amount of water or the organic solvent used in the washing step can be an amount that can sufficiently replace the solvent in the wet gel and permit washing. The amount can be, for example, an amount of 3 to 10 times the volume of the wet gel. The washing can be repeated, for example, until the water content in the wet gel after the washing becomes 10% by mass or less with respect to the mass of silica.

The temperature environment in the washing step can be a temperature equal to or lower than the boiling point of the solvent used in washing. In the case of using, for example, methanol, a temperature on the order of 30 to 60° C. may be used.

In the solvent replacement step, the solvent of the wet gel is replaced with a predetermined solvent for replacement in order to suppress the shrinkage in the drying step mentioned later. In this respect, replacement efficiency can be improved by warming. Specific examples of the solvent for replacement include, in the case of drying under atmospheric pressure at a temperature lower than the critical point of the solvent used in drying in the drying step, a solvent having low surface tension mentioned later. On the other hand, in the case of performing supercritical drying, examples of the solvent for replacement include ethanol, methanol, 2-propanol, dichlorodifluoromethane, and carbon dioxide, and mixed solvents of two or more of these.

Examples of the solvent having low surface tension include ones whose surface tension at 20° C. is 30 mN/m or lower. The surface tension may be 25 mN/m or lower or may be 20 mN/m or lower. Examples of the solvent having low surface tension include: aliphatic hydrocarbons such as pentane (15.5), hexane (18.4), heptane (20.2), octane (21.7), 2-methylpentane (17.4), 3-methylpentane (18.1), 2-methylhexane (19.3), cyclopentane (22.6), cyclohexane (25.2), and 1-pentene (16.0); aromatic hydrocarbons such as benzene (28.9), toluene (28.5), m-xylene (28.7), and p-xylene (28.3); halogenated hydrocarbons such as dichloromethane (27.9), chloroform (27.2), carbon tetrachloride (26.9), 1-chloropropane (21.8), and 2-chloropropane (18.1); ethers such as ethyl ether (17.1), propyl ether (20.5), isopropyl ether (17.7), butyl ethyl ether (20.8), and 1,2-dimethoxyethane (24.6); ketones such as acetone (23.3), methyl ethyl ketone (24.6), methyl propyl ketone (25.1), and diethyl ketone (25.3); and esters such as methyl acetate (24.8), ethyl acetate (23.8), propyl acetate (24.3), isopropyl acetate (21.2), isobutyl acetate (23.7), and ethyl butyrate (24.6) (the surface tension at 20° C. is indicated within the parentheses, and the unit is [mN/m]). Among these, an aliphatic hydrocarbon (hexane, heptane, etc.) has low surface tension and is excellent in working environmental performance. Also, among these, a hydrophilic organic solvent such as acetone, methyl ethyl ketone, or 1,2-dimethoxyethane is used and thereby, can also serve as the organic solvent in the washing step. Among these, one whose boiling point at normal pressure is 100° C. or lower may be used from the viewpoint that drying in the drying step mentioned later is easier. The solvent may be used alone or by mixing two or more types.

An amount that can sufficiently replace the solvent in the wet gel after the washing can be used as the amount of the solvent used in the solvent replacement step. The amount can be, for example, an amount of 3 to 10 times the volume of the wet gel.

A temperature equal to or lower than the boiling point of the solvent used in replacement can be used as the temperature environment in the solvent replacement step. In the case of using, for example, heptane, a temperature on the order of 30 to 60° C. may be used.

As mentioned above, in the case where silica particles are contained in the gel, the solvent replacement step is not always essential. A presumed mechanism is as follows. In the case where the silica particles are not contained, it is preferable for suppressing shrinkage in the drying step to replace the solvent in the wet gel with a predetermined solvent for replacement (solvent having low surface tension). On the other hand, in the case where the silica particles are contained, it is considered that the silica particles function as a support of a three-dimensional network skeleton, whereby the skeleton is supported so that the shrinkage of the gel in the drying step is suppressed. Thus, it is considered that the gel can be directly transferred to the drying step without replacing the solvent used in washing. As mentioned above, although the simplification of the washing and solvent replacement step through the drying step is possible, the execution of the solvent replacement step is not excluded by any means.

(Drying Step)

In the drying step, the wet gel washed and (if necessary) solvent-replaced as described above is dried.

The drying approach is not particularly limited, and publicly known drying under normal pressure, supercritical drying or freeze drying can be used. Among these, drying under normal pressure or supercritical drying can be used from the viewpoint of easily manufacturing an aerogel layer having a low density. Also, drying under normal pressure can be used from the viewpoint that production at a low cost is possible. In the present embodiment, the normal pressure means 0.1 MPa (atmospheric pressure).

The aerogel layer according to the present embodiment can be obtained, for example, by drying the washed and (if necessary) solvent-replaced wet gel under atmospheric pressure at a temperature lower than the critical point of the solvent used in drying. Considering that, particularly, drying at high temperatures accelerates the evaporation rate of the solvent and may cause large cracks in the gel, the drying temperature may be, for example, 20 to 500° C. and may be 60 to 120° C., though differing depending on the type of the replaced solvent (solvent used in washing in the case of not performing solvent replacement). The drying time can be set to, for example, 4 to 120 hours, though also differing depending on the volume of the wet gel and the drying temperature. In the present embodiment, the acceleration of drying by applying pressure lower than the critical point within a range not inhibiting productivity is also encompassed by the drying under normal pressure.

In the aerogel layer formation step according to the present embodiment, predrying may be performed before the drying step from the viewpoint of suppressing cracks in the aerogel ascribable to rapid drying. The predrying temperature may be, for example, 60 to 180° C. and may be 90 to 150° C. The predrying time may be, for example, 1 to 30 minutes, though differing depending on the volume of the aerogel layer and the drying temperature.

The drying method in the drying step may be, for example, supercritical drying. The supercritical drying can be performed by a publicly known approach. Examples of the method for supercritical drying include a method of removing the solvent at a temperature and pressure equal to or higher than the critical point of the solvent contained in the wet gel. Alternative examples of the method for supercritical drying include a method of dipping the wet gel in liquefied carbon dioxide, for example, under conditions on the order of 20 to 25° C. and 5 to 20 MPa, thereby replacing the whole or a portion of the solvent contained in the wet gel with carbon dioxide, which has a lower critical point than that of the solvent, and then removing the carbon dioxide alone or a mixture of the carbon dioxide and the solvent.

The aerogel layer obtained by such drying under normal pressure or supercritical drying may be further subjected to additional drying at 105 to 200° C. under normal pressure for approximately 0.5 to 2 hours. By this, an aerogel layer having a low density and small pores is more easily obtained. The additional drying may be performed at 150 to 200° C. under normal pressure.

{Barrier Layer Formation Step}

In the barrier layer formation step, for example, a composition for barrier layer formation (e.g., a composition containing the siloxane compound and, if necessary, other components) is contacted with the aerogel layer, if necessary followed by heating and drying, to thereby form a barrier layer on the aerogel layer. In the case where the siloxane compound is, for example, a condensate of an organosilicon compound having a hydrolyzable functional group, the composition for barrier layer formation may be in a form containing the organosilicon compound having a hydrolyzable functional group (e.g., methyltrimethoxysilane). Alternatively, in the case where the member with an aerogel layer comprises an additional layer between the aerogel layer and the barrier layer, the composition for barrier layer formation can be contacted with the additional layer.

The contacting method can be appropriately selected according to the type of the composition for barrier layer formation, the thickness of the barrier layer, or the water repellency of the aerogel layer, etc. Examples of the contacting method include dip coating, spray coating, spin coating, and roll coating. Among them, spray coating can be suitably used from the viewpoint of easily suppressing the penetration of the composition for barrier layer formation into the aerogel.

In the barrier layer formation step, heat treatment may be performed from the viewpoint of drying and fixing the composition for barrier layer formation, and washing or drying may be performed from the viewpoint of removing impurities.

The member with an aerogel layer of the present embodiment as described above comprises a main body part, the aerogel layer, and a barrier layer containing a siloxane compound in this order and therefore has excellent thermal insulation properties, flame retardance, heat resistance and oil resistance (oil absorption suppressing effect). Owing to such advantages, the member with an aerogel layer of the present embodiment can be applied to purposes as a thermal insulating material, etc. in various environments such as cryogenic vessels, the space field, the architecture field, the automobile field, the field of household appliances, the semiconductor field and industrial facilities. The member with an aerogel layer of the present embodiment is particularly suitable for thermal insulation purposes in engines and the like where liquids and mists of oils and the like are present.

### EXAMPLES

Although the present invention will be further specifically described below with reference to Examples, the present invention is not limited by these Examples.

(Provision of Main Body Part)

An aluminum alloy plate: A6061P (manufactured by Takeuchi Metal & Foil Co., Ltd., product name, dimension: 300 mm×300 mm×0.5 mm, alumite-treated) was provided as a main body part.

(Preparation of Sol Coating Liquid)

[Sol Coating Liquid 1]

100.0 parts by mass of PL-2L (product name, manufactured by Fuso Chemical Co., Ltd., average primary particle diameter: 20 nm, solid content: 20% by mass) as a silica particle-containing raw material, 120.0 parts by mass of water, 80.0 parts by mass of methanol and 0.10 parts by mass of acetic acid as an acid catalyst were mixed to obtain a mixture. 60.0 parts by mass of methyltrimethoxysilane (manufactured by Shin-Etsu Chemical Co., Ltd., product name: LS-530; hereinafter, abbreviated to “MTMS”) and 40.0 parts by mass of dimethyldimethoxysilane (manufactured by Shin-Etsu Chemical Co., Ltd., product name: LS-520; hereinafter, abbreviated to “DMDMS”) were added as silicon compounds to this mixture, and reacted at 25° C. for 2 hours. 40.0 parts by mass of 5% concentration of ammonia water were added thereto as a base catalyst to obtain sol coating liquid 1.

[Sol Coating Liquid 2]

100.0 parts by mass of PL-2L as a silica particle-containing raw material, 100.0 parts by mass of water, 0.10 parts by mass of acetic acid as an acid catalyst, 20.0 parts by mass of cetyl trimethyl ammonium bromide (hereinafter, abbreviated to “CTAB”) as a cationic surfactant and 120.0 parts by mass of urea as a thermally hydrolyzable compound were mixed to obtain a mixture. 60.0 parts by mass of MTMS and 20.0 parts by mass of DMDMS as a silicon compound and 20.0 parts by mass of a both terminally difunctional alkoxy-modified polysiloxane compound having a structure represented by the above formula (B) (hereinafter, abbreviated to “polysiloxane compound A”) as a polysiloxane compound were added to this mixture, and reacted at 25° C. for 2 hours. Then, sol-gel reaction was performed at 60° C. for 1.0 hour to obtain sol coating liquid 2.

The “polysiloxane compound A” was synthesized as follows: first, in a 1 L three-neck flask equipped with a stirrer, a thermometer and a Dimroth condenser, 100.0 parts by mass of dimethylpolysiloxane having silanol groups at both ends (manufactured by Momentive Performance Materials Inc., product name: XC96-723), 181.3 parts by mass of methyltrimethoxysilane and 0.50 parts by mass of t-butylamine were mixed and reacted at 30° C. for 5 hours. Then, volatile matter was removed by heating this reaction solution under reduced pressure of 1.3 kPa at 140° C. for 2 hours, to obtain the both terminally difunctional alkoxy-modified polysiloxane compound (polysiloxane compound A).

(Preparation of Composition for Barrier Layer Formation)

[Composition 1 for Barrier Layer Formation]

RSN-0806 RESIN (manufactured by Dow Corning Toray Co., Ltd., product name) as a silicone-containing composition and fused silica (manufactured by Admatechs Co., Ltd., SC2050-KNK) as a filler were mixed and diluted by using a methyl isobutyl ketone solvent such that the solid content became 30% by mass to obtain a composition 1 for barrier layer formation. The content of the fused silica with respect to the total volume of the barrier layer was set to 20% by volume.

[Composition 2 for Barrier Layer Formation]

100 parts by mass of MTMS, 2 parts by mass of acetic acid, and 40 parts by mass of water were mixed and stirred at room temperature for 4 hours to obtain a composition 2 for barrier layer formation.

### Example 1

The sol coating liquid 1 was applied onto the main body part by using an air brush (manufactured by ANEST IWATA Corporation, product name: HP-CP) such that the thickness after gelling became 100 m, and gelled at 60° C. for 30 minutes to obtain a structure. Then, the obtained structure was transferred to a closed vessel and aged at 60° C. for 12 hours.

The aged structure was dipped in 2000 mL of water and washed over 30 minutes. Next, the resultant was dipped in 2000 mL of methanol and washed at 60° C. over 30 minutes. Washing with methanol was further performed twice while the methanol was replaced with a fresh one. Next, the resultant was dipped in 2000 mL of methyl ethyl ketone, and solvent replacement was performed at 60° C. over 30 minutes. Washing with methyl ethyl ketone was further performed twice while the methyl ethyl ketone was replaced with a fresh one. The washed and solvent-replaced structure was dried under normal pressure at 120° C. for 6 hours to form an aerogel layer 1 on the main body part.

The composition 1 for barrier layer formation was applied onto the aerogel layer 1 formed on the main body part by using an air brush and then heated and cured at 150° C. for 2 hours to prepare an aerogel composite structure 1. The total thickness of the aerogel layer 1 and the barrier layer 1 was 120 μm.

### Example 2

The sol coating liquid 2 was applied onto the main body part by using a bar coater such that the thickness after gelling became 100 μm, and gelled at 60° C. for 30 minutes to obtain a structure. Then, the obtained structure was transferred to a closed vessel and aged at 60° C. for 12 hours.

The aged structure was subjected to washing, solvent replacement and drying in the same way as in Example 1 to form an aerogel layer 2 containing aerogel having structures represented by the above formulas (2), (3), (4) and (5) on the main body part.

The composition 2 for barrier layer formation was applied onto the aerogel layer 2 formed on the main body part by using an air brush and then heated and cured at 150° C. for 2 hours to prepare an aerogel composite structure 2. The total thickness of the aerogel layer 2 and the barrier layer 2 was 120 m.

### Comparative Example 1

The aerogel layer 1 was formed on the main body part by the same method as in Example 1. This was used as an aerogel composite structure IC according to Comparative Example.

TABLE 1

| Item | Aerogel layer | Barrier layer |
|---|---|---|
| Example 1 | Aerogel layer 1 | Barrier layer 1 |
| Example 2 | Aerogel layer 2 | Barrier layer 2 |
| Comparative Example 1 | Aerogel layer 1 | Absent |

<Various Evaluations>

### (Oil Resistance Evaluation)

1 μL of engine oil (manufactured by EMG Lubricants GK., Mobil 1 5W-30) was added dropwise to a surface on the side opposite to the main body part of the aerogel composite structure obtained in each Example or Comparative Example, and in the case where the liquid droplets remained on the surface without penetration, good oil resistance was determined; and in the case where the liquid droplets disappeared from the surface, poor oil resistance was determined.

(Surface Falling Property Evaluation)

A surface on the side opposite to the main body part was rubbed with a finger as to the aerogel composite structure of each Example or Comparative Example, and the presence or absence of attachment to the finger was visually confirmed. In the case where the attachment was absent, good surface falling properties were determined; and in the case where the attachment was present, poor surface falling properties were determined.

(Thermal Insulation Property Evaluation)

The aerogel composite structure of each Example or Comparative Example was placed on a hot plate with a surface temperature of 70° C. such that a surface on the side opposite to the main body part became an undersurface, and heated, and 10 minutes later, the highest temperature of the surface was measured by thermography (manufactured by Apiste Corporation, Infrared Thermoviewer FSV-1200-L16). The sample temperature before the heating and room temperature were 23° C.

(Flame Retardance Evaluation)

Flame retardance evaluation was conducted by contacting flame with a surface layer opposite to the main body part of the aerogel composite structure obtained in each Example or Comparative Example in accordance with JIS A 1322 (Testing Method for Incombustibility of Thin Materials for Buildings).

(Heat Resistance Evaluation)

The aerogel composite structure obtained in each Example or Comparative Example was placed on a hot plate with a surface temperature of 200° C. such that a surface on the side opposite to the main body part became an undersurface, and heated at 200° C. for 5 minutes. After the heating, visual observation was performed to evaluate appearance such as deformation, discoloration, or peeling. In the case where there was no change in the visual observation, good heat resistance was determined; and in the case where deformation, discoloration, peeling, or the like occurred, poor heat resistance was determined.

TABLE 2

| | | | | | Thermal | | |
|---|---|---|---|---|---|---|---|
| | | | | | insulation | | |
| | | | | Surface | property | | |
| | Aerogel | Barrier | Oil | falling | (surface | Flame | Heat |
| Item | layer | layer | resistance | property | temperature) | retardance | resistance |
| Example 1 | Aerogel | Barrier | Good | Good | 35° C. | Anti-flame | Good |
| | layer 1 | layer 1 | | | | grade 1 | |
| Example 2 | Aerogel | Barrier | Good | Good | 36° C. | Anti-flame | Good |
| | layer 2 | layer 2 | | | | grade 1 | |
| Comparative | Aerogel | Absent | Poor | Poor | 34° C. | Anti-flame | Good |
| Example 1 | layer 1 | | | | | grade 1 | |

From Table 2, oil resistance, surface falling properties, thermal insulation properties, flame retardance and heat resistance are good in Examples. Therefore, they can be suitably used even in the presence of an oil or even in a high-temperature environment. On the other hand, Comparative Example 1 is inferior in oil resistance and surface falling properties and does not produce effects equivalent to Examples.

### REFERENCE SIGNS LIST

1 . . . Member with an aerogel layer, 3 . . . Main body part, 4 . . . Aerogel layer, 5 . . . Barrier layer, L . . . Bounding rectangle, P . . . Silica particles.

1. A member with an aerogel layer comprising:
a main body part;
the aerogel layer; and
a barrier layer containing a siloxane compound
in this order.

2. The member with an aerogel layer according to claim 1, wherein the aerogel layer comprises aerogel being a dried product of wet gel, the wet gel being a condensate of sol containing at least one selected from the group consisting of a silicon compound having a hydrolyzable functional group or a condensable functional group, and a hydrolysis product of the silicon compound having a hydrolyzable functional group.

3. The member with an aerogel layer according to claim 1, wherein the aerogel layer comprises aerogel being a dried product of wet gel, the wet gel being a condensate of sol containing silica particles.

4. The member with an aerogel layer according to claim 3, wherein an average primary particle diameter of the silica particles is 1 to 500 nm.

5. The member with an aerogel layer according to claim 2, wherein the aerogel layer comprises aerogel being a dried product of wet gel, the wet gel being a condensate of sol containing silica particles.

6. The member with an aerogel layer according to claim 5, wherein an average primary particle diameter of the silica particles is 1 to 500 nm.
